(19) United States
(12) Patent Application Publication
(10) Pub. No.: US 2005/0241308 A1
(43) Pub. Date: Nov. 3, 2005

(54) Integral radiator and charge air cooler

(76) Inventors: Muhammad H. Iqbal, Canton, MI (US); Stafford Fearnside, Howell, MI (US); Joseph Rahaim, Farmington Hills, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/836,054

(22) Filed: Apr. 30, 2004

(51) Int. Cl. F02B 29/04; F02C 3/30

(52) U.S. Cl. 60/599

(57) ABSTRACT

An integral radiator and charge air cooler for an internal combustion engine includes a first heat exchanger fluidly connected to a closed loop engine cooling system and a second heat exchanger fluidly connected in an open loop compressed combustion air supply system. The first and second heat exchangers are integrally formed as a unit and are internally fluidly isolated. The engine cooling system includes a coolant pump for circulating coolant through the engine. The combustion air supply system generally includes an air compressor, and the compressed air flows from the air compressor through the second heat exchanger to a combustion chamber of the engine.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

The invention relates to cooling systems for automobile engines, and more particularly to an integral radiator and charge air cooler for a turbocharged or supercharged internal combustion engine.

2. Description of Related Art

The available real estate in automobile engine compartments has become ever more precious as the need for more efficient construction and packaging has come to the forefront. This is compounded by the increasing complexity of automobile engines and the growing number of features that has become the norm. Components that by their nature require a great deal of volume, and those that require specific placement in the engine compartment, are of particular concern to the designers.

One such family of components consists of the various heat exchangers, such as radiators, transmission coolers, condensers and charge air coolers, which require exposure to a ready flow of moving outside air. This requirement is compounded by the common requirement to fit all of these components within the same engine compartment.

In turbocharged or supercharged engines, intake air is compressed prior to mixing with the fuel to increase the oxygen concentration for combustion. The process of compression heats the air, decreasing its density, contrary to the goal of increasing the oxygen concentration. The compressed air is therefore commonly run through a “charge air cooler,” a heat exchanger that draws heat from the compressed intake air prior to mixing with the fuel. Current turbocharged engines have separate heat exchangers to maintain the engine temperature and the charge air temperature.

It would be advantageous to provide an integrated unit that integrates the function of multiple heat exchangers in order to capitalize on the available air flow, and to provide flexibility in engine compartment design by reducing the area necessary to provide sufficient cooling capacity.

### BRIEF SUMMARY OF THE INVENTION

An integral radiator and charge air cooler for an internal combustion engine includes a first heat exchanger fluidly connected to a closed loop engine cooling system and a second heat exchanger fluidly connected in an open loop compressed combustion air supply system. The first and second heat exchangers are integrally formed as a unit and are internally fluidly isolated. The engine cooling system includes a coolant pump for circulating coolant through the engine. The combustion air supply system generally includes an air compressor, and the compressed air flows from the air compressor through the second heat exchanger to a combustion chamber of the engine.

In one embodiment, the air compressor is motivated by a turbine driven by exhaust gases of the internal combustion engine. In a further embodiment, the air compressor is an accessory driven by the internal combustion engine.

In a further embodiment, the first heat exchanger and the second heat exchanger are arranged side-by-side. In yet a further embodiment, the second heat exchanger is arranged above the first heat exchanger.

### BRIEF DESCRIPTION OF THE SEVERAL VIEWS OF THE DRAWINGS

The present invention will become more fully understood from the detailed description and the accompanying drawings, wherein:

FIG. 1 is a front view of an integral radiator and charge air cooler according to the invention.

FIG. 2 is a front view of a further embodiment of an integral radiator and charge air cooler according to the invention.

FIG. 3 is a schematic of an engine and compressed air cooling system incorporating the integral radiator and charge air cooler of FIG. 1.

### DETAILED DESCRIPTION OF THE INVENTION

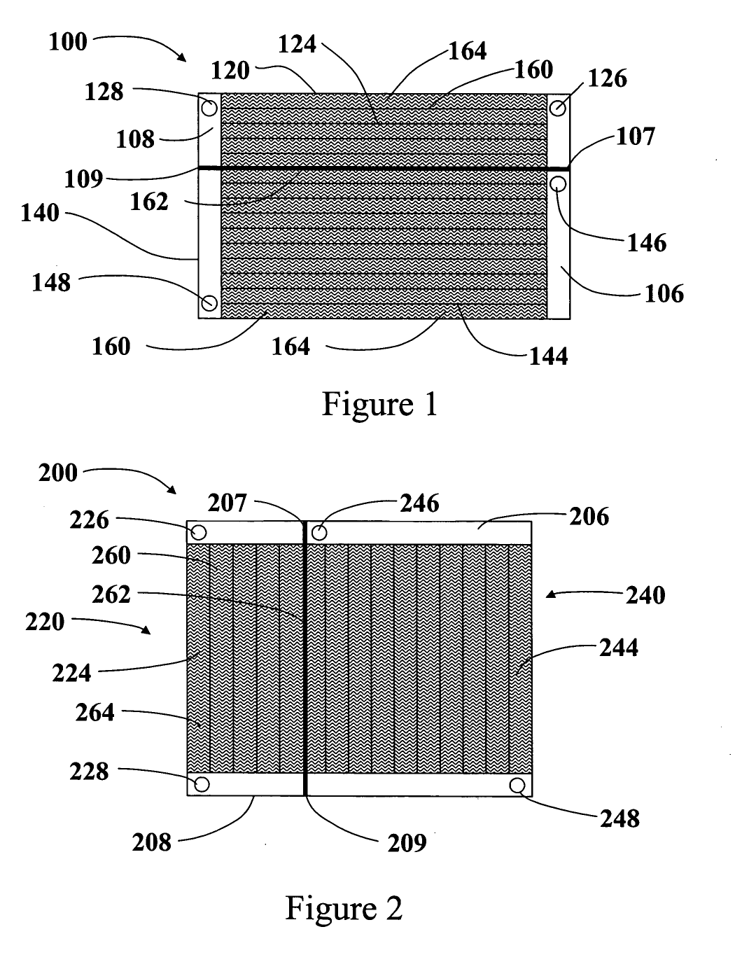

Referring to FIG. 1, an integral radiator and charge air cooler 100 according to the invention comprises an integrally formed heat exchanger 160 having an inlet side 106 and an outlet side 108. The integral radiator and charge air cooler 100 is divided into a radiator 140 for connection to an engine cooling system and a charge air cooler 120 for connection to a compressed combustion air system. The engine is generally understood to be an internal combustion engine.

The body of the heat exchanger 160 includes an internal divider 162, which separates a charge air cooler portion 124 from a radiator portion 144. Each of the inlet side 106 and outlet side 108 also incorporate internal dividers 107, 109 respectively for fluidly isolating the heat exchangers comprising the radiator 140 and charge air cooler 120.

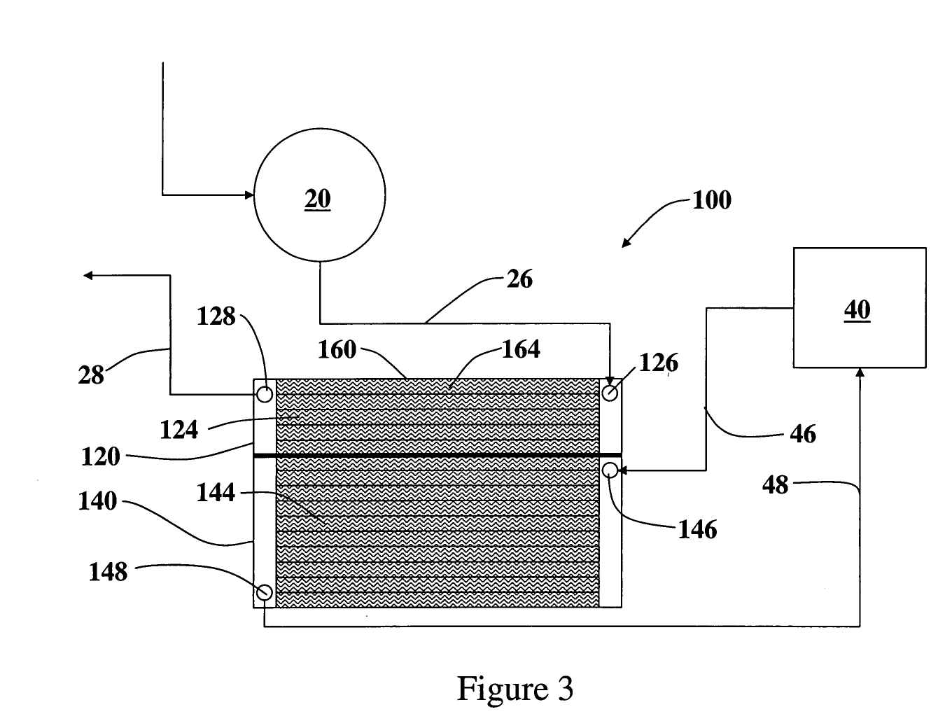

The charge air cooler 120 is internally configured to optimally pass a gaseous fluid, namely compressed air, to encourage the exchange of heat between the compressed air and atmospheric air passing over the fins 164 of the charge air cooler portion 124 of the heat exchanger 160. Charge air cooler 120 includes a charge air cooler inlet 126 that is adapted for fluid connection to an air compressor 20 via a conduit 26 (see FIG. 3). Charge air that has passed through charge air cooler 120 exits through charge air cooler outlet 128 and is conveyed for combination with fuel and combustion via conduit 28.

Radiator 140 is configured for a liquid-air heat exchange interface (see FIGS. 1, 3). Liquid coolant is conveyed from the engine cooling system 40 by a coolant pump through conduit 46 to the radiator inlet 146. The coolant pump can be an accessory driven by the internal combustion engine, or can be driven by an electric motor. Heat is exchanged as the coolant passes through internal passages thermally linked with the fins 164 of the heat exchanger. Atmospheric air passes over the fins 164 to convey thermal energy from the radiator portion 144 of the heat exchanger 160. The coolant exits the heat exchanger 160 at radiator outlet 148 and is returned to the engine cooling system through conduit 48.

Referring now to FIG. 2, a further embodiment of the integral radiator and charge air cooler 200 arranges a heat exchanger 260 with vertical internal partitions 262, 207, 209. The radiator 240 and charge air cooler 220 are arranged side-by-side. In this down-flow configuration, the inlet side 206 is arranged at an upper portion, and the outlet side 208 is arranged at a lower portion, of the integral radiator and charge air cooler 200.

In the same fashion as the embodiment of FIG. 1, radiator 240 includes a radiator inlet 246 and a radiator outlet 248, adapted for fluid connection to an engine cooling system 40. The heat exchanger 260 is divided by internal partition 262 to form a radiator portion 244 and a charge air cooler portion 224. Each portion of the heat exchanger 260 is defined by internal passages surrounded by fins 264 for the dissipation of thermal energy. Charge air cooler 220 includes a charge air cooler inlet 226 and a charge air cooler outlet 228 for fluidly connecting to an air compressor 20 and combustion chamber respectively.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the scope of the appended claims.

1. An integral radiator and charge air cooler for an internal combustion engine, comprising:
a first heat exchanger fluidly connected to a closed loop engine cooling system comprising a coolant pump for circulating coolant through an engine block; and
a second heat exchanger fluidly connected in an open loop compressed combustion air supply system comprising an air compressor, whereby compressed combustion air flows from the air compressor through the second heat exchanger to a combustion chamber of the engine, wherein the first and second heat exchangers are integrally formed as a unit and are internally fluidly isolated.

2. The integral radiator and charge air cooler of claim 1, wherein the air compressor is motivated by a turbine driven by exhaust gases of the internal combustion engine.

3. The integral radiator and charge air cooler of claim 1, wherein the air compressor is an accessory driven by the internal combustion engine.

4. The integral radiator and charge air cooler of claim 1, wherein the first heat exchanger and the second heat exchanger are arranged side-by-side.

5. The integral radiator and charge air cooler of claim 1, wherein the second heat exchanger is arranged above the first heat exchanger.

6. The integral radiator and charge air cooler of claim 1, wherein the coolant pump is an accessory driven by the internal combustion engine.

7. The integral radiator and charge air cooler of claim 1, wherein the coolant pump is driven by an electric motor.
